(19) United States
(12) Patent Application Publication
(10) Pub. No.: US 2009/0053365 A1
(43) Pub. Date: Feb. 26, 2009

(54) Refreshment system having peel away nutrient and supplement packages

(76) Inventors: Marni Markell Hurwitz, Far Hills, NJ (US); Ernest D. Buff, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/894,456

(22) Filed: Aug. 21, 2007

(51) Int. Cl. A23L 1/30; A23L 1/302; A23L 1/303; B65D 81/32

(52) U.S. Cl. 426/73; 426/115; 426/72

(57) ABSTRACT

A liquid containing vessel is provided with one or more peel away packages housing nutritional and supplement ingredients. The packages are made from sealed polyethylene film having a continuous aluminum coating, which is moisture resistant and enables the packages to withstand washing of the vessel. Each of the packages has a notch therein to facilitate tearing. One or more packages are torn open, and the ingredients contained therein are emptied into the bottled water to create a custom beverage. The nutritional ingredients can include a vitamin and/or mineral composition or an electrolyte composition. The supplement composition can include a flavor enhancer, a taste enhancer or a medically effective agent.

### BACKGROUND OF THE INVENTION

1. Field of the Invention

The present invention relates to a fluid refreshment vessels; and, more particularly, to a water bottle having thereon one or more peel away packages containing vitamins, minerals, hydration enhancers or medically effective compositions that may be stirred into the water prior to consumption.

2. Description of the Prior Art

Many patents address issues related to providing nutritional supplements in a powder form, pill form or mixture appointed for addition to a beverage. It has been recognized that adding nutritional supplements such as vitamin C or iron supplements into a drink results in discoloration of the drink. Furthermore, such addition of nutritional supplements deteriorates taste properties of the drink and reduces its nutrient efficacy during storage prior to consumption.

U.S. Pat. Nos. 5,032,411, 5,114,723 to Stray-Gundersen disclose beverage compositions for human consumption. Aqueous hypotonic beverage compositions appointed for oral administration contain physiologically essential electrolytes, nutrient minerals, carbohydrates, and other ingredients advantageous to a human body. The hypotonic beverage composition comprises an aqueous solution, either carbonated or non-carbonated, electrolytes, carbohydrates, low-caloric sweetener, and edible acid components. The concentrate is a dry powder appointed to be mixed with water to form the aqueous beverage. The concentrate additive is not contained in a peel away package attached to a water bottle.

U.S. Pat. No. 5,609,897 to Chandler, et al. discloses a powdered beverage concentrate or additive fortified with calcium and vitamin D. This powdered beverage concentrate contains calcium glycerophosphate, vitamin D, vegetable oil, a gum, vitamin C, an acidulant, a sweetener, a glucose polymer and a flavoring agent. The powdered beverage concentrate contains from 7.2 to 18.0% by wt. of calcium source. A beverage can be made by reconstituting the beverage concentrate with water, fruit juice, or any other suitable liquid matrix. The beverage concentrate contains vegetable oil in liquid form; and is not a free flowing powder. The beverage concentrate is not present in a peel away package attached to a water bottle.

U.S. Pat. No. 5,681,606 to Hutchison, et al. discloses a method of preparing a water-based beverage. A beverage is prepared in the form of a dilute aqueous solution, suspension or dispersion of an encapsulated product. The capsule is added to a potable liquid. Capsule material breaks down when submerged in the liquid, causing the capsule to release its contents and dissolve. When provided in this manner, the product can be confined within the capsule in liquid form, and can therefore disperse or dissolve in water more readily. Additionally, the capsule tends to sink to the bottom of the body of water before releasing its contents, thereby ensuring that the contents are released within the body of water, and not at the water surface. The added capsules are not contained in a peel away package attached to the side of the water bottle.

U.S. Pat. No. 6,287,596 to Murakami, et al. discloses quickly disintegratable compression-molded materials and a process for producing the sane. This quickly disintegratable compression-molded material contains erythritol, a tetrahydric sugar alcohol produced by the fermentation of glucose, and fillers such as starches, celluloses, and sugar alcohols and vitamins. The vitamins include vitamin A, vitamin D, vitamin E (such as d-.alpha.-tocopherol acetate), vitamin B₁ (such as thiamin hydrochloride), vitamin B₂ (such as riboflavin), vitamin B₆ (such as pyridoxine hydrochloride), vitamin C (such as ascorbic acid and sodium ascorbate), vitamin B₁₂ (such as hydroxocobalamin acetate), nicotinamide, calcium pantothenate, and pantethine. The quickly disintegratable compression-molded material exhibits rapid disintegration and dissolution when placed in the oral cavity or water. It has high strength and does not collapse during the manufacturing process. The quickly disintegratable compression-molded material is not a free flowing finely divided powder contained in a peel away package that may be added to water in a bottle.

U.S. Pat. No. 6,472,007 to Bezek, et al. discloses a consumables container with a multi-functional cap. This container houses food and other perishable products. It comprises a multi-functional cap that allows for the storage of multiple products separately within the container and consumption of the products while “on the go.” The multi-functional cap nests over and seals the mouth end of the container. This allows for the nesting of a sub-container inside the cap, and permits the products to be resealed without contaminating each other. The container is ergonomically and stylishly shaped with a comfortable handgrip. Each of the products is contained within the multifunctional cap, and is not present as a powder in a peel away package attached to a water bottle.

U.S. Pat. Nos. 6,681,958, 6,681,958 to Sorenson, et al. disclose supplement compartment for beverage container. A supplement compartment in the lid of a liquid container contains individually accessible compartments for vitamin, mineral, analgesic, antibiotic or other medicine, flavor or other color additive or nutritional additive. The supplement may be a solid, or a semi-solid, or a liquid or a gas. The solid may comprise a pill, tablet, granule, powder or the like. The semi-solid may comprise a paste, cream, gel, or the like. The liquid may comprise a hydrous or nonhydrous solution. The supplement is not contained in a peel away package attached to the side of a water bottle.

U.S. Pat. No. 7,014,876 to Iwasaki, et al. discloses a packaged beverage. This packaged beverage comprises ingredients (A) and (B). Ingredient (A) is a non-polymer catechins (green tea extract) in an amount of from 0.092 to 0.5 g/100 mL of beverage. Ingredient (B) is an alcoholic precipitate in an amount of 0.015 g/100 mL of beverage or less in terms of the amount of magnesium, at a weight ratio (A)/(B) ranging from 30/1 to 50000/1. The packaged beverage is said to be best suited for health promotion. Drinking of it permits transfer of a large amount of catechins to the blood form the beverage, and the absorption within the body is excellent. The A and B constituents are dissolved in the water and are not provided in a peel away package.

U.S. Pat. No. 7,090,878 to Mehansho, et al. discloses mineral fortified water. This water composition is fortified with at least one mineral and has a pH between about 2.5 and 9.5 with a redox potential that satisfies the equation 0≧RP−(A−B*pH) wherein RP is the redox potential in millivolts of the mineral-containing water composition, pH is the pH of the mineral-containing water composition, A is 400 and B is 20. The mineral is selected from calcium, iron, zinc, copper, manganese, iodine, magnesium, and their mixtures. The mineral-fortified water composition is free of flavor or sweetener compounds with no metallic taste or after-taste, a Hunter calorimetric “b” reading of less than 5.0, and an NTU turbidity value of less than 5.0. The mineral-fortified water composition may also contain other nutrients and vitamins, for example, vitamin A, vitamin C, vitamin E, niacin, thiamin, vitamin B₆, vitamin B₂, vitamin B₁₂, folic acid, selenium, and pantathonic acid. Both the minerals and vitamins are added to the water composition and are not present in peel away packages attached to a water bottle.

U.S. Pat. No. 7,115,297 to Stillman discloses nutritionally fortified liquid composition with added value delivery systems/elements/additives. This bottled water-like composition includes a fiber-water as the base for new compositions. It creatively uses encapsulations and viscosity modifications as delivery vehicles, thereby designing products that target obesity, diabetes, heart health, improved general health and well being, stress, depression, pain, fostering a healthy digestive tract, and the binding and removing of toxins from the body, thus intending to reduce the incidences of cancer, etc. Immune enhancing, anti-bacterial and anti-viral, compositions are manipulated via viscosity changes and encapsulations. These additive compositions are not contained in peel away packages and added to bottled water prior to consumption. Rather they are mixed into fiber-enriched water that is thereafter sold for consumption.

There remains a need in the art for a refreshment system wherein nutrients, or medicaments may be selected and added to a water-containing vessel by the consumer prior to consumption to thereby provide nutritional ingredients or medically effective agents according to the needs of the consumer.

### SUMMARY OF THE INVENTION

The present invention is directed to a liquid-containing vessel, such as a bottle, carton or the like, having an outer-side wall to which are attached one are more peel away packages containing nutritional, flavor and taste enhancing additives or medically effective agents. The user peels off one or more attached packages and adds the ingredients contained within the package to fluid contained in the vessel prior to consuming the mixture.

There are several advantages obtained by adding packaged ingredients to liquid, such as water, in this manner as compared to systems where the water and ingredients are pre-mixed and then sold for consumption. A consumer does not have to purchase a plurality of water bottles, each containing a different flavor, taste enhancing ingredient, vitamin etc. Instead, the consumer selects the peel away package and adds the ingredients to the bottled water before consuming the mixture. If two of the constituents interact chemically, due to the short time of dissolution extant, their functionality is maintained. An example of this type of mixture is the addition of citric acid with a bicarbonate to create carbon dioxide bubbles. Vitamins that deteriorate over time due to exposure to oxygen or light are preserved. The vitamins remain in powder form contained within the peel away package, which is sealed to prevent their exposure to moisture and shields them from light.

The powder contained in the peel away packages should be free flowing and should easily dissolve in the bottled water. Powdery ingredients may be pulverized to a fine mesh particle size to enable free flowing and have large enough surface area for quick dissolution. For example 100 mesh particles have an average diameter of 140 microns while a 325 mesh particles have a diameter of only 44 microns thereby presenting a larger surface area. A 5 micron particle size results in a significantly larger surface area available for dissolution. Liquid or sticky ingredients may be microencapsulated in gelatin capsules, which are free flowing or readily dissolving.

Since moisture permeates easily into peel away packages, they should be made from a packaging material that prevents moisture diffusion or permeation. Packaging materials of this functionality are readily available and are typically polyethylene films with an aluminized coating. The packages may have a notch to readily open the package for delivering the contents to the bottled water.

The peel away packages may be attached to the packages by means of a transfer film. The transfer film is typically a tape with adhesive on both sides. One side of the transfer tape adheres to the peel away package while the other side of the tape adheres to the external side wall of the water bottle.

In the first embodiment, the water bottle with peel away nutrient and supplement packages is a throwaway water bottle with one or more peel away packages. The user may choose one or more nutrient and supplement packages and discard the bottle with unused peel away packages.

In the second embodiment, the water bottle with peel away nutrient and supplement packages is a refillable water bottle with one or more peel away packages. The user may wash the bottle and refill it with fresh water. The user may also purchase one or more peel away nutrient and supplement packages and attach them to the external sidewall surface side of the water bottle after peeling off a protective tape cover to expose the adhesive.

In a third embodiment, the water bottle with peel away nutrient and supplement packages forms one of a plurality of bottles, which may be sold as a “six pack”, or “kit”? Still further, the bottle with peel away nutrient and supplement packages is thermally insulated, while the remaining bottles of the six pack are not. This arrangement permits refilling of the thermal bottle with water from the non-insulated bottles (which can be refrigerated or otherwise brought to a cool temperature before their liquid contents are added to the thermal bottle). A refill package containing peel away nutrient and supplement packages can be marketed separately from the kit. This arrangement permits continued reuse of the thermal bottle long after consumption of liquid contained by the non-insulated bottles of the kit.

The adhesive that attaches the packages to the external surface of the water bottle is similar to the Post-It™ product and does not leave behind a glue coating on the bottle external surface. Since the peel away packages are moisture resistant, washing the bottle does not cake or damage the nutrition and supplement composition contained within the packages.

### BRIEF DESCRIPTION OF DRAWINGS

The invention will be more fully understood and further advantages will become apparent when reference is had to the following detailed description and the accompanying drawings, in which:

FIG. 1 is a schematic view of the water bottle with peel away nutrient and supplement packages; and

FIG. 2 is a schematic view of the peel away nutrient and supplement packages designed for attachment to a refillable water bottle.

### DESCRIPTION OF THE PREFERRED EMBODIMENTS

Water bottles have been widely accepted by consumers due to their health benefits. Water has zero calories and hydrates the user. Throwaway water bottles are generally purchased by consumers in bulk quantities occupying large trunk space and storage space. Several companies sell washable water bottles made from polycarbonate or high-density polyethylene polymers.

More recently, the trend has been to market water bottles with sweeteners, juice drinks, taste and flavor enhancers and vitamin and/or mineral supplements. Prolonged storage of vitamins and/or mineral supplement containing bottled water results in reduction in potency of vitamins and/or minerals as well taste and flavor deterioration. Preservation of taste and flavor requires addition of chemicals to the packaging or the bottled water, which may not be of nutrition value and in fact may harm the user in the long run.

It is therefore advantageous to add the supplements to bottled water just before consuming from peel away packages. This assures that vitamin and/or mineral nutrients have full potency; that medically effective supplements are free from chemical reaction products; and that flavor and taste enhancing supplements provide expected flavor and taste. In addition, the user may select more than one peel away package to create a custom bottled water beverage according to taste preferences.

The key requirement for the proper functioning of peel away packages is that the ingredients contained therein are free flowing and dissolve readily. In the case of powders, the dissolution rate of powder material is function of its composition and its particle size. While the composition is pre-selected, it is generally not a variable, but the particle size of the powder can be controlled by the manufacturing process of the peel away packages. Consider a volume of V centimeter cube of a powder with an average particle size of d microns. N is the number of particles needed to fill the space of V cubic centimeters. The following equation shows the relationship between V, d and N.

$$V = N ( \frac{4}{3} π \frac{{d}^{3}}{8} )$$

The surface area S of the N particles of diameter d is given by the equation:

$$S = N π {d}^{2} = \frac{6 V}{π d}$$

Therefore decreasing the particle size from 100 mesh (140 microns diameter) to 325 mesh (44 micron diameter) results in a surface area increase of 140/44 or 3.18. If the particle size were reduced to 5 microns, the surface area will increase by 140/5 or 28 times. The finer sized particles typically are free flowing.

When liquid or semi-solid ingredients are to be contained in the peel away package they should to be encapsulated, preferably microencapsulated in a gelatin capsule. The gelatin capsules dissolve away releasing the peel away package content to the bottled water. Capsules contained within the peel away package are free flowing. The propensity of gelatin capsules to promote a free flowing particle characteristic followed by rapid dissolution in water makes gelatin the preferred encapsulant.

Ingredients in the peel away packages may be vitamins, minerals, taste enhancers, flavoring agents, medically effective agents and the like. Typical vitamins in powder form includes vitamin C, B1, B2, B6, B12, folic acid coenzyme (CQ10) and D. Typical liquid or semi-solid vitamins include vitamin A and E. Minerals in powder form include calcium compounds, preferably calcium citrate, magnesium compound, preferably magnesium citrate, chromium compound, preferably chromium picolinate or Niacin chromium GTF complex, zinc compound, selenium compound iron compounds and others. Anti-oxidants include coenzymes. Hydrating substances include sodium and potassium chloride. Medically effective agents may include aspirin, and other over the counter medications in proper dosages. Flavors may include orange flavor, lemon or lime flavor, guava flavor, mango flavor, dragon fruit flavor, green tea, caffeine or guarana.

One medically effective agent which is particularly advantageous comprises gum Arabic powder. Gum Arabic is a natural product, occurring as an exudate from the trunks and branches of the Acacia Senegal tree. Gum Arabic power is water soluble. A six ounce dosage is sufficient to support an adult for twenty-four hours. In some cases of disease, it is considered that a solution of Gum Arabic may for a time constitute the exclusive drink and food of the patient.

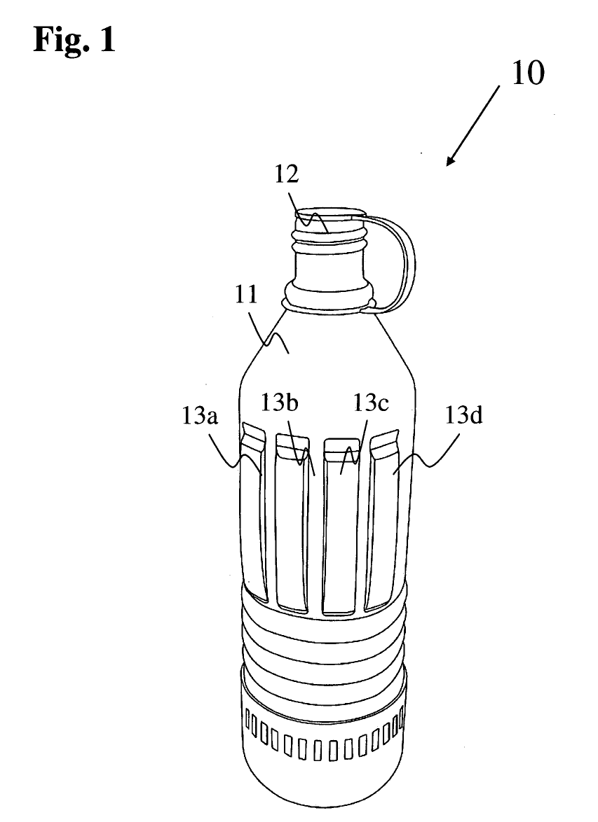

FIG. 1 schematically illustrates at 10 the components of a water bottle 11 with a cap 12. A plurality of peel away packages 13a through 13d contain nutritional ingredients and supplement ingredients. For example, 13a may be labeled multivitamin plus. 13b may be labeled fresh citrus plus. 13c may be labeled electrolyte plus. 13d may be labeled stress relied plus. There may be other packets that produce carbon dioxide bubbles or fizz when added to bottled water and may include citric acid and bicarbonate. The cap 12 is first removed. One or more selected peel away packages may be torn and the ingredients contained therein are delivered into the bottled water. If necessary, the bottle may be recapped and shaken to promote uniform distribution of the added ingredients and promote dissolution.

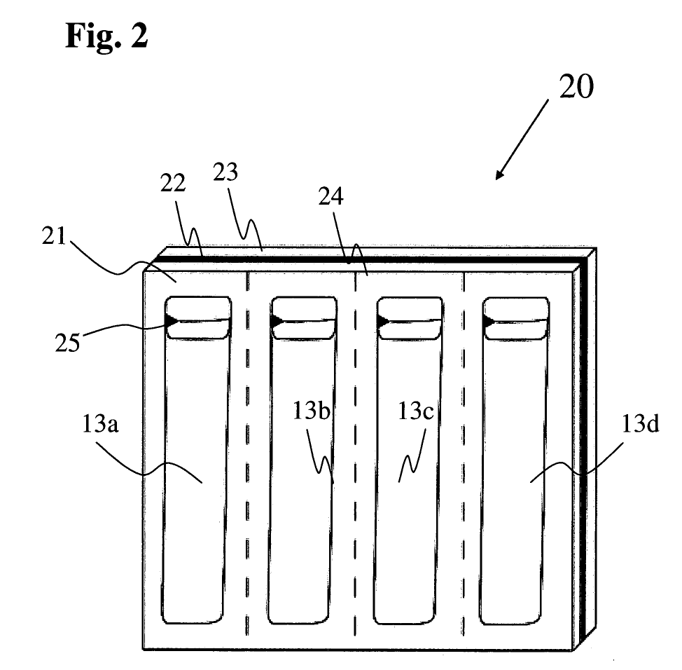

FIG. 2 illustrates generally at 20 a typical peel away strip 21 with a plurality of packages 13a through 13d, each containing various ingredients. The backside of the strip has an adhesive coating 22 and a protective tape 23 covering the adhesive. This protective tape 23 is removed prior to the application of the strip on a washable water bottle. Perforations at 24 permit the removal of any of the strips 13a through 13d. The notch at 25 allows easy tearing of the package after its removal to discharge the contents into the bottled water.

The water bottle with peel away nutrient and supplement packages comprises, in combination, the following salient features:
1. a water bottle having a closure cap and an external sidewall surface;
2. the water bottle being a disposable one time use bottle or a washable refillable water bottle;
3. one or more peel away nutrient and supplement packages attached with removable adhesive to the external sidewall surface of the water bottle;
4. the packages containing nutritional and supplement ingredients;
5. the nutritional ingredients including vitamins and/or minerals, antioxidants, and electrolytes;
6. the supplement ingredients including flavor and taste enhancers, medically effective agents and carbon dioxide bubble producing chemical combinations;
7. the nutritional and supplement ingredients being packaged in a sealed moisture impermeable film packet capable of being washed;
8. the moist impermeable film being a polyethylene sheet coated with a continuous aluminum layer;
9. the packages having a notch for easy tearing and for discharging ingredients contained into bottled water;
whereby the user may select one or more nutritional ingredients or supplement ingredients for addition to bottled water, thereby customizing the drink beverage without having to buy, transport and store multiple premixed and commercially sold compositions contained within water bottles.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A liquid containing vessel, comprising:
a. a closure cap and an external sidewall surface;
b. one or more peel away nutrient and supplement packages adhesively attached to said external sidewall surface of the vessel;
c. said nutritional packages containing nutritional ingredients;
d. said supplement packages containing supplement ingredients;
e. said one or more packages being adapted to be peeled away and torn to deliver said nutritional or supplement ingredients into liquid within said vessel;
whereby the user may select one or more nutritional ingredients or supplement ingredients to add to liquid within said vessel, thereby customizing a drink beverage without having to buy, transport and store multiple commercially sold vessels containing premixed liquid compositions.

2. A liquid containing vessel as recited by claim 1, wherein said vessel is a disposable polymeric water bottle.

3. A liquid containing vessel as recited by claim 1, wherein said vessel is a washable refillable, polymeric water bottle.

4. A liquid containing vessel as recited by claim 1, wherein said peel away packages comprise a sealed, continuous, aluminum-coated polyethylene film.

5. A liquid containing vessel as recited by claim 1, wherein said peel away packages have a notch therein to facilitate tearing.

6. A liquid containing vessel as recited by claim 1, wherein said adhesive is a transfer film tape.

7. A liquid containing vessel as recited by claim 1, wherein said nutritional and supplement ingredients are in the form of fine powder.

8. A liquid containing vessel as recited by claim 7, wherein the fine powder has a particle diameter in the range of 140 to 5 microns.

9. A liquid containing vessel as recited by claim 1, wherein said nutritional and supplement ingredients are in the form of an encapsulated liquid or semi-solid particles.

10. A liquid containing vessel as recited by claim 9, wherein said encapsulant is gelatin.

11. A liquid containing vessel as recited by claim 1, wherein said nutritional ingredient includes a vitamin composition and a mineral composition.

12. A liquid containing vessel as recited by claim 1, wherein said nutritional ingredient is an electrolyte composition.

13. A liquid containing vessel as recited by claim 11, wherein said vitamin composition includes vitamin A, vitamin B1, B2, B6, B12, vitamin C, vitamin E and coenzyme (CQ10).

14. A liquid containing vessel as recited by claim 11, wherein said mineral composition includes calcium compound, magnesium compound, chromium compound, zinc compound selenium compound and iron compound.

15. A liquid containing vessel as recited by claim 1, wherein said supplement ingredient comprises at least one of a flavor enhancing ingredient, a taste enhancing ingredient and a medically effective agent.

16. A liquid containing vessel as recited by claim 15, wherein said flavor enhancing ingredient includes orange flavor, lemon or lime flavor, guava flavor, mango flavor, dragon fruit flavor, green tea, caffeine and guarana.

17. A liquid containing vessel as recited by claim 15, wherein said taste enhancing ingredient includes a sweetener and an acidifier.

18. A liquid containing vessel as recited by claim 15, wherein said medically effective agent includes aspirin and over the counter medications.

19. A fluid refreshment system, comprising:
a. a liquid containing vessel having a closure cap and an external sidewall surface;
b. one or more peel away nutrient and supplement packages adhesively attached to said external sidewall surface of the vessel;
c. said nutritional packages containing nutritional ingredients;
d. said supplement packages containing supplement ingredients;
e. said one or more packages being adapted to be peeled away and torn to deliver said nutritional or supplement ingredients into liquid within said vessel;
whereby the user may select one or more nutritional ingredients or supplement ingredients to add to liquid within said vessel, thereby customizing a drink beverage without having to buy, transport and store multiple commercially sold vessels containing premixed liquid compositions.

20. A fluid refreshment system as recited by claim 19, wherein said liquid containing vessel is a disposable polymeric water bottle.

21. A fluid refreshment system as recited by claim 19, wherein said vessel is a washable refillable, polymeric water bottle.

22. A fluid refreshment system as recited by claim 19, wherein said peel away packages comprise a sealed, continuous, aluminum-coated polyethylene film.

23. A fluid refreshment system as recited by claim 19, wherein said peel away packages have a notch therein to facilitate tearing.

24. A fluid refreshment system as recited by claim 19, wherein said adhesive is a transfer film tape.

25. A fluid refreshment system as recited by claim 19, wherein said nutritional and supplement ingredients are in the form of fine powder.

26. A fluid refreshment system as recited by claim 25, wherein the fine powder has a particle diameter in the range of 140 to 5 microns.

27. A fluid refreshment system as recited by claim 19, wherein said nutritional and supplement ingredients are in the form of an encapsulated liquid or semi-solid particles.

28. A fluid refreshment system as recited by claim 27, wherein said encapsulant is gelatin.

29. A fluid refreshment system as recited by claim 19, wherein said nutritional ingredient includes a vitamin composition and a mineral composition.

30. A fluid refreshment system as recited by claim 19, wherein said nutritional ingredient is an electrolyte composition.

31. A fluid refreshment system as recited by claim 29, wherein said vitamin composition includes vitamin A, vitamin B1, B2, B6, B12, vitamin C, vitamin E and coenzyme (CQ10).

32. A fluid refreshment system as recited by claim 29, wherein said mineral composition includes calcium compound, magnesium compound, chromium compound, zinc compound selenium compound and iron compound.

33. A fluid refreshment system as recited by claim 29, wherein said supplement ingredient comprises at least one of a flavor enhancing ingredient, a taste enhancing ingredient and a medically effective agent.

34. A fluid refreshment system as recited by claim 33, wherein said medically effective agent is Gum Arabic.
